(19) United States
(12) Patent Application Publication
(10) Pub. No.: US 2014/0059192 A1
(43) Pub. Date: Feb. 27, 2014

(54) Ethernet Based Local IP Access

(71) Applicant: György Miklós, Pilisborosjeno (HU)

(72) Inventor: György Miklós, Pilisborosjeno (HU)

(73) Assignee: TELEFONAKTIEBOLAGET L M ERICSSON (PUBL), Stockholm (SE)

(21) Appl. No.: 14/009,899

(22) PCT Filed: Aug. 26, 2011
(86) PCT No.: PCT/IB2011/053759

§ 371 Date: Oct. 23, 2013

Related U.S. Application Data
(60) Provisional application No. 61/472,729, filed on Apr. 7, 2011.

(51) Int. Cl. H04L 29/12; H04W 8/26

(52) U.S. Cl. CPC H04L 61/255; H04W 8/26
USPC 709/221

(57) ABSTRACT

An H(e)NB-LGW node of a wireless telecommunications network having UEs and an old H(e)NB-LGW node. The H(e)NB-LGW node includes a network interface unit which receives a context for a UE that has moved to the H(e)NB-LGW node. The H(e)NB-LGW node includes a processing unit which causes a MAC broadcast to be sent by the network interface unit to a local network that updates a mapping of an IP address of the UEs to a MAC address of the H(e)NB-LGW after mobility. The broadcast causes an old H(e)NB-LGW node to stop owning the IP address for the UE. An MME node of a wireless telecommunications network having UEs, a new H(e)NB-LGW node, a local network and an SGW. A method of an H(e)NB-LGW node of a wireless telecommunications network having UEs. Methods of an MME node of a wireless telecommunications network having UEs, a new H(e)NB-LGW node, a local network and an SGW.

### TECHNICAL FIELD

The present invention is related to an H(e)NB-LGW node which receives a context for a UE that has moved to the H(e)NB-LGW node and which causes a MAC broadcast to be sent to a local network that updates a mapping of an IP address of the UEs to a MAC address of the H(e)NB-LGW after mobility. (As used herein, references to the “present invention” or “invention” relate to exemplary embodiments and not necessarily to every embodiment encompassed by the appended claims.) More specifically, the present invention is related to an H(e)NB-LGW node which receives a context for a UE that has moved to the H(e)NB-LGW node and which causes a MAC broadcast to be sent to a local network that updates a mapping of an IP address of the UEs to a MAC address of the H(e)NB-LGW after mobility, where the broadcast causes an old H(e)NB-LGW node to stop owning the IP address for the UE and the context includes the LGW context and the RAN context from the old H(e)NB-LGW to the H(e)NB-LGW node.

### BACKGROUND

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

3GPP vendors and operators are defining ways to provide efficient local connectivity using the 3GPP 3G/HSPA and LTE air interfaces. 3GPP Release 9 and release 10 have defined HNB and HeNB nodes in the architecture. These are typically small base stations, also known as femto base stations, that provide a small cell (of a few meters in radius) which can cover e.g., a house or a flat. In the basic solution, these H(e)NBs use some fixed connectivity (e.g., ADSL connection through a fixed ISP) and establish an IPsec tunnel towards the mobile operator core network to connect the H(e)NB securely to the mobile operator's core network.

As an extension feature, Local IP Access (LIPA) feature allows a terminal to connect to the local network, e.g., to access a local server or a local printer. This could be used e.g. in a home or small office environment to connect to other local devices in a similar way as WLAN is used today. Additionally, it is possible to extend the LIPA feature and access the internet via the local network.

3GPP has defined one solution to the LIPA feature in Release 10 [1,2], as described in more detail below. That solution has some limitations: the H(e)NB function is co-located with the GW function, and there is no mobility support: handover between H(e)NBs is not supported, and also handover from a H(e)NB to a macro (e)NB is not supported.

3GPP is going to start standardization for release 11 and study solutions which lift some of the above restrictions. The typical use case is a bigger network such as an enterprise network which has multiple H(e)NBs. A solution is needed which can provide mobility within the enterprise network, and possibly between the enterprise network and the macro network.

The release 10 solution for Local IP Access is defined in 3GPP TS 23.401[1] section 4.3.16 for LTE and 3GPP TS 23.060 [2] section 5.3.14 for 3G.

The solution is illustrated in FIG. 1 for the LTE case.

The main features of the solution are as follows.
Local traffic uses a separate local PDN connection/PDP context.
The HeNB has a co-located LGW (Local GW) function which includes a subset of PGW functions. This includes IP address allocation, and termination of the S5 interface.
The SGW functionality resides in the mobile operator core network as usual for a regular connection. Consequently, for the LIPA connection, the HeNB and PGW functionality reside in the local node, while the SGW functionality resides in the mobile operator core. This would normally result in a routing detour (FIG. 1).
There is a “shortcut” functionality in the HeNB to avoid the routing detour. If, for a given connection, both the PGW and HeNB functions are in the same node, the SGW node is skipped, and a node-internal forwarding function delivers packets between the PGW and the HeNB functions.

Note that the solution adopted in 3GPP is equivalent to one embodiment of the patent publication [3].

This solution is well suited for release 10, however this does not support mobility within an enterprise network as required for release 11. The difficulty is that if the H(e)NB role is separate from the GW due to mobility, the solution has no way to avoid the routing detour via the SGW in the operator network.

A solution with two variants is presented in [5] and [6] which is illustrated in FIG. 2. (FIG. 2 illustrates the LTE case, the solution also applies to 3G with corresponding entities.)

This solution resembles the release 10 solution in that the SGW is kept in the mobile operator core network. The enterprise network is allowed to have multiple H(e)NBs and a standalone GW node (referred to as LGW). The solution is based on a new interface shown as Sxx between the HeNB and the LGW, which is used as a “direct tunnel” which bypasses the SGW in the operator core.

The two variants differ in how the direct user plane on Sxx is controlled. In [5], Sxx is user plane only, and the control signaling for setting up the user plane goes via the MME and the SGW in the mobile operator core network. This has the advantage that it has smaller impact on the mobility procedures themselves. However, there is a disadvantage: the MME and the SGW still has to deal with new information elements and manage signaling to and from the LGW, and hence this variant would require both the MME and the SGW nodes in the operator network to be upgraded and manage the local mobility signaling. Variant [6] on the other hand does not impact the SGW, instead it uses control signaling on Sxx to set up the user plane. This helps to make the deployment more independent of the mobile operator's GW node upgrades. However, this introduces new control messages into mobility procedures. This makes the solution more complex. Furthermore, introducing a new variant to mobility management procedures has the risk of further architecture divergence, where the network has a new mobility behavior. Some network deployments may choose this new mobility behavior while other deployments would use the current mobility behavior, leading to potential market fragmentation.

Ericsson presented a solution in [8] which is based on relocating the SGW function into the enterprise network for mobility when the terminal is located in the enterprise network. This solution has the advantage that it can re-use the existing mobility mechanisms. On the other hand, the solution requires SGW relocations when the terminals enter or leave the enterprise network which introduces added complexity and signaling load. Additionally, the SGW function in the enterprise network would also be used for the non-offloaded operator connection, meaning a higher load on the local SGW as well as more dependence on it which is not desirable. The solution may also have limited roaming capabilities and more difficulty for LI due to the local SGW function, since it is difficult to perform LI in a local SGW, and it is not realistic to let the local SGW have roaming relationships.

A solution from NEC is presented in S2-102293 [4] which is based on tunneling between different GWs. However, this solution requires extensive changes to the 3GPP procedures and hence it is deemed too complex.

A solution by LGE is presented in [7] which uses ARP to provide mobility. Every HeNB in the local network is collocated with a Local Gateway (L-GW) function. Upon inter-HeNB handover the L-GW is relocated i.e. the terminal's IP address that was hosted on the source L-GW is now relocated and hosted on the target L-GW. The target L-GW advertises itself as the owner of the UE's IP address using ARP and hence mobility is provided.

The solution presented by this invention is similar to the LGE solution in [7] in that the LGW is collocated with the H(e)NB and the mobility is solved by mapping the terminal's IP address to a MAC address at the current H(e)NB. However, this solution in [7] has a number of drawbacks.
The relocation of the LGW functionality is performed during the handover preparation phase. This is problematic because the handover may fail eventually despite the preparation, and in that case the LGW function is already relocated to the new LGW while the H(e)NB function remains at the old node. It is not clear how this discrepancy is resolved. This issue leads to an additional complexity impact and possible performance degradation.
The solution, as described in [7], has issues regarding when the old LGW context is released. The description mentions a first, non-optimized method, where there is a short period of time when the UE's IP address is not owned by any LGW, since the context is released in the old LGW before the new one is established in the new LGW. In this period of time, packet losses may occur since there is no LGW that is responsible for the UE's IP address. The description also mentions a second, optimized method, where the old LGW context is released after the new LGW context is established using a signaling message that may take some time to reach the old LGW. But having a context in both the new and old LGWs for a period of time is problematic, since both LGWs may then respond to ARP requests for the IP address of the UE.
The described solution has issues with maintaining the S5 interface between the SGW and the LGW. The description first shows a non-optimized method which uses signaling via the SGW to first release the old LGW context and then establish the new LGW during handover. However, this would introduce significant additional signaling load and complexify the handover procedures. The description also shows an optimized method when the additional signaling is not present. However, in the optimized method the SGW does not take part in the handover signaling. Hence the SGW cannot get an information about the new LGW, and therefore the S5 cannot be maintained between the new LGW and the SGW. This is problematic because S5 would be needed in idle mode if the UE gets a new downlink packet and the terminal would need to be paged, because paging is initiated when the first downlink packet is sent to the SGW in idle mode.
In case UE based DHCP is used for IP address allocation, the context in the LGW may change when the IP address is assigned. However, the MME does not get information about this change. As a consequence, the MME will not be able to provide information for a new LGW to establish the context for the UE. There may be other information which is not available in the MME, such as PCO, to enable the setup of the new LGW context. This problem is not addressed in [7].
When the new LGW sends a gratuitous ARP to update the binding of the IP address to the MAC address of the new LGW, the old LGW at the old H(e)NB may interpret this as an address conflict when it is using RFC5227, IPv4 Address Conflict Detection. This can lead to an error notification towards the user about node misconfiguration, and also that the old and new LGWs both try to claim the same address if they are following RFC5227 as specified. The solution in [7] does not provide a solution for this potential problem.

Additionally, it must be mentioned that all of the solutions with a standalone local GW are at a disadvantage, since a standalone local GW needs to be deployed, configured and managed. This is not only an extra complexity and cost, but it also makes the solution harder and more costly to maintain. Enterprise IT administrators are now used to setting up base stations (based on WLAN technology) and they are used to providing wireless access to an enterprise network for terminals. But an enterprise IT administrator may find it complex to manage a standalone 3GPP GW node. This is also true if the GW functionality is integrated to one or more base station nodes. Hence it is preferable to have a solution which does not require such a GW.

### BRIEF SUMMARY OF THE INVENTION

The present invention pertains to an H(e)NB-LGW node of a wireless telecommunications network having UEs and an old H(e)NB-LGW node. The H(e)NB-LGW node comprises a network interface unit which receives a context for a UE that has moved to the H(e)NB-LGW node. The H(e)NB-LGW node comprises a processing unit which causes a MAC broadcast to be sent by the network interface unit to a local network that updates a mapping of an IP address of the UEs to a MAC address of the H(e)NB-LGW after mobility. The broadcast causes an old H(e)NB-LGW node to stop owning the IP address for the UE.

The present invention pertains to a MME node of a wireless telecommunications network having UEs, a new H(e)NB-LGW node, a local network and an SGW. The MME node comprises a network interface unit which receives an LGW context. The MME node comprises a memory in which the LGW context is stored. The MME node comprises a processing unit which sends the LGW context through the network interface unit to the new H(e)NB-LGW node after idle to connected transition or mobility into the local network.

The processing unit may update the LGW context in the memory when the LGW context changes.

The present invention pertains to an MME node of a wireless telecommunications network. The MME node comprises a network interface unit. The MME node comprises a processing unit which sends through the network interface unit LGW address and TEID information to the SGW during S1 release procedure.

The present invention pertains to a method of an H(e)NB-LGW node of a wireless telecommunications network having UEs. The method comprises the steps of receiving at a network interface unit of the H(e)NB-LGW node a context for a UE that has moved to the H(e)NB-LGW node. There is the step of causing with a processing unit of the H(e)NB-LGW node a MAC broadcast to be sent by the network interface unit to a local network that updates a mapping of an IP address of the UEs to a MAC address of the H(e)NB-LGW after mobility. The broadcast causes an old H(e)NB-LGW node to stop owning the IP address for the UE.

The present invention pertains to a method of an MME node of a wireless telecommunications network having UEs, a new H(e)NB-LGW node, a local network and an SGW. The method comprises the steps of receiving at a network interface unit an LGW context. There is the step of storing the LGW context in a memory. There is the step of sending with a processing unit the LGW context through the network interface unit to the new H(e)NB-LGW node after idle to connected transition or mobility into the local network.

The present invention pertains to a method of an MME node of a wireless telecommunications network having an SGW. There is the step of sending with the processing unit through the network interface unit the LGW address and TEID information to the SGW during S1 release procedure.

### BRIEF DESCRIPTION OF THE DRAWING

In the accompanying drawings, the preferred embodiment of the invention and preferred methods of practicing the invention are illustrated in which:

FIG. 1 is a schematic representation of local access for the LTE case regarding an integral network having multiple H(e)NBs.

FIG. 2 is a schematic representation of the LTE case regarding mobility within an enterprise network.

FIG. 3 is a schematic representation of the architecture of the present invention.

FIG. 4 shows the signaling diagram for setting up a new local connection regarding the present invention.

FIG. 5 shows the signaling for X2 handover within the enterprise network of the present invention.

FIG. 6 shows the signaling for S1 handover within the enterprise network of the present invention.

FIG. 7a shows the signaling for S1 release initiated from the RAN.

FIG. 7b shows the signaling for S1 release initiated from the MME.

FIG. 8 shows the signaling for service request within the enterprise network of the present invention.

FIG. 9 shows the signaling for paging within the enterprise network of the present invention.

FIG. 10 shows the signalling in regard to LGW context update.

FIG. 11 is a schematic representation regarding when the terminal moves out of the enterprise network.

FIG. 12 shows the signaling regarding X2 handover out of the enterprise network.

FIG. 13 shows the signaling regarding X2 handover into the enterprise network.

FIG. 14 shows S1 handover out of the enterprise.

FIG. 15 shows S1 handover into the enterprise.

FIG. 16 shows the signaling regarding 3G and the present invention.

FIG. 17 is a block diagram of an H(e)NB-LGW node of the present invention.

FIG. 18 is a block diagram of an MME of the present invention.

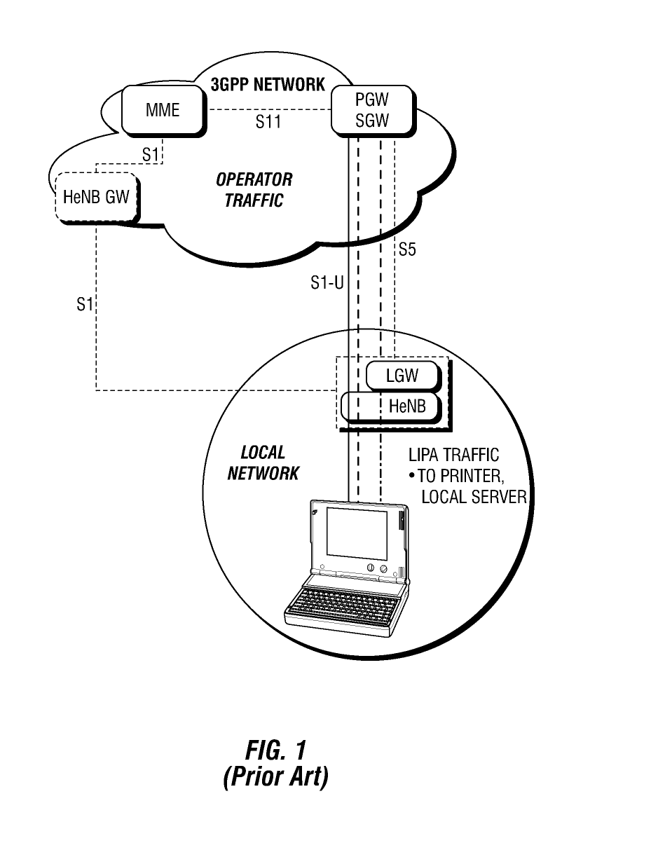

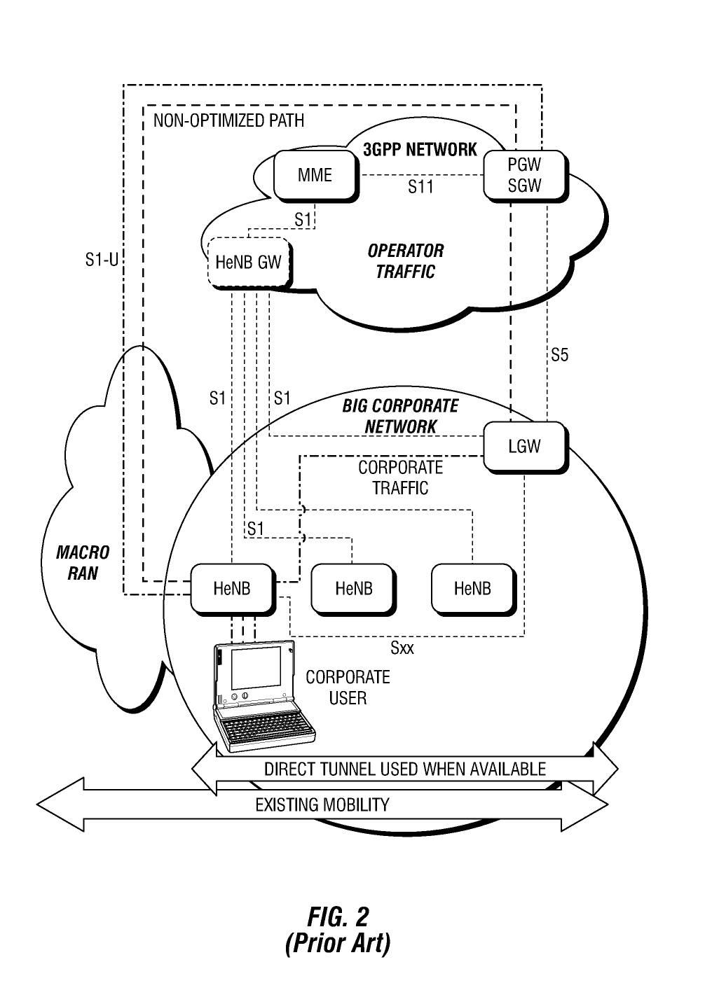

### DETAILED DESCRIPTION

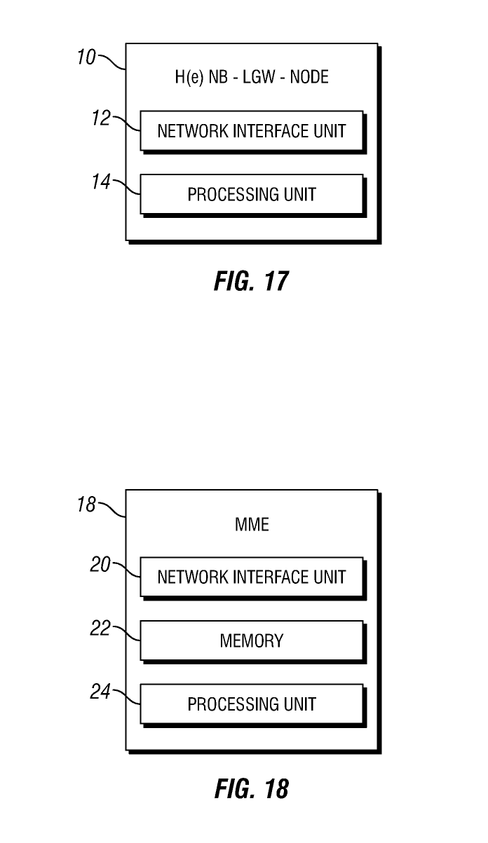

Referring now to the drawings wherein like reference numerals refer to similar or identical parts throughout the several views, and more specifically to FIG. 17 thereof, there is shown an H(e)NB-LGW node 10 of a wireless telecommunications network having UEs 16 and an old H(e)NB-LGW node. The H(e)NB-LGW node 10 comprises a network interface unit 12 which receives a context for a UE 16 that has moved to the H(e)NB-LGW node 10. The H(e)NB-LGW node 10 comprises a processing unit 14 which causes a MAC broadcast to be sent by the network interface unit 12 to a local network that updates a mapping of an IP address of the UEs to a MAC address of the H(e)NB-LGW after mobility. The broadcast causes an old H(e)NB-LGW node to stop owning the IP address for the UE 16.

The context which is received by the network interface unit 12 may include the LGW context and the RAN context from the old H(e)NB-LGW to the H(e)NB-LGW node 10. The processing unit 14 may add new information elements to existing messages. The processing unit 14 may assign a MAC address to the UE 16 during the establishment of a local connection, such that the MAC address is unique to the UE 16 in the local network. The MAC address may be stored in the LGW context of the UE 16. The processing unit 14 may use the assigned unique MAC address as a source L2 address to encapsulate the UE's uplink IP packets before the UE 16 sends them to the local network via the network interface unit 12.

The network interface unit 12 may receive an indication whether or not mobility out of a local network is enabled. The processing unit 14 may buffer downlink packets in idle mode received by the network interface unit 12 except a first packet of the downlink packets if it is indicated that mobility out of the local network is not enabled. The broadcast may include a gratuitous ARP packet for IPv4, or a Neighbor Advertisement for IPv6. The broadcast may include an L2 frame with the UE's unique MAC address as the source.

The present invention pertains to a MME 18 node, as shown in FIG. 18, of a wireless telecommunications network having UEs 16, a new H(e)NB-LGW node 10, a local network and an SGW 26. The MME 18 node comprises a network interface unit 12 which receives an LGW context. The MME 18 node comprises a memory 22 in which the LGW context is stored. The MME 18 node comprises a processing unit 14 which sends the LGW context through the network interface unit 12 to the new H(e)NB-LGW node 10 after idle to connected transition or mobility into the local network. The processing unit 14 may update the LGW context in the memory 22 when the LGW context changes.

The present invention pertains to an MME 18 node of a wireless telecommunications network. The MME 18 node comprises a network interface unit 12. The MME 18 node comprises a processing unit 14 which sends through the network interface unit 12 LGW address and TEID information to the SGW 26 during S1 release procedure.

The present invention pertains to a method of an H(e)NB-LGW node 10 of a wireless telecommunications network having UEs. The method comprises the steps of receiving at a network interface unit 12 of the H(e)NB-LGW node 10 a context for a UE 16 that has moved to the H(e)NB-LGW node 10. There is the step of causing with a processing unit 14 of the H(e)NB-LGW node 10 a MAC broadcast to be sent by the network interface unit 12 to a local network that updates a mapping of an IP address of the UEs to a MAC address of the H(e)NB-LGW after mobility. The broadcast causes an old H(e)NB-LGW node to stop owning the IP address for the UE 16.

The context which is received by the network interface unit 12 may include the LGW context and the RAN context from the old H(e)NB-LGW to the H(e)NB-LGW. There may be the step of the processing unit 14 adding new information elements to existing messages.

There may be the step of assigning with the processing unit 14 a MAC address to the UE 16 during the establishment of a local connection, such that the MAC address is unique to the UE 16 in the local network. The MAC address may be stored in the LGW context of the UE 16. The processing unit 14 may use the assigned unique MAC address as a source L2 address to encapsulate the UE's uplink IP packets before the UE 16 sends them to the local network via the network interface unit 12. There may be the step of the network interface unit 12 receiving an indication whether or not mobility out of a local network is enabled. There may be the step of the processing unit 14 buffering downlink packets in idle mode received by the network interface unit 12 except a first packet of the downlink packets if it is indicated that mobility out of the local network is not enabled. The broadcast may include a gratuitous ARP packet for IPv4, or a Neighbor Advertisement for IPv6. The broadcast may include an L2 frame with the UE's unique MAC address as the source.

The present invention pertains to a method of an MME 18 node of a wireless telecommunications network having UEs, a new H(e)NB-LGW node 10, a local network and an SGW 26. The method comprises the steps of receiving at a network interface unit 12 an LGW context. There is the step of storing the LGW context in a memory 22. There is the step of sending with a processing unit 14 the LGW context through the network interface unit 12 to the new H(e)NB-LGW node 10 after idle to connected transition or mobility into the local network There may be the step of the processing unit 14 updating the LGW context in the memory 22 when the LGW context changes.

The present invention pertains to a method of an MME 18 node of a wireless telecommunications network having an SGW 26. There is the step of sending with the processing unit 14 through the network interface unit 12 the LGW address and TEID information to the SGW 26 during S1 release procedure.

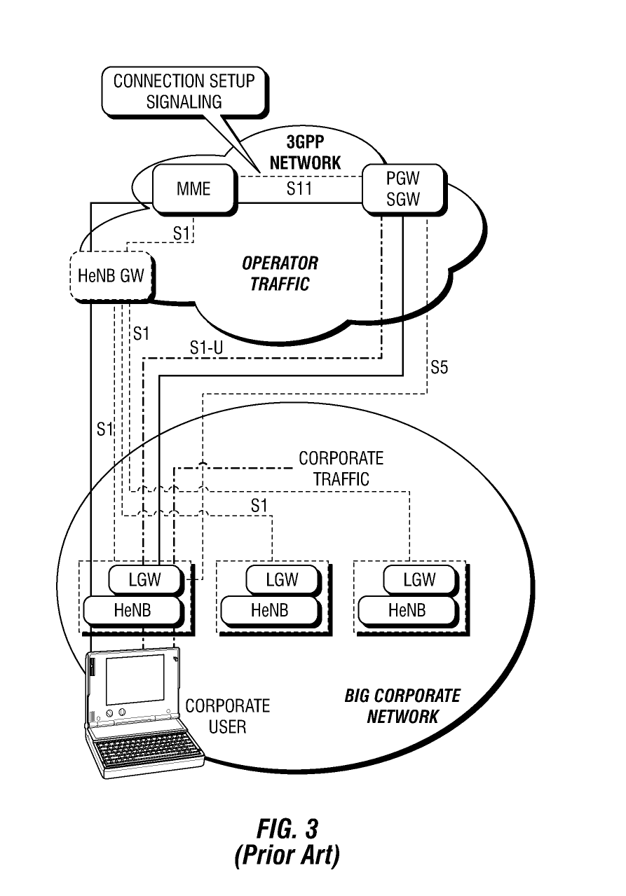

In the operation of the invention, the invention describes a solution to Local IP Access in an enterprise network with mobility support. FIG. 3 illustrates the architecture for the solution in the LTE case. Note that the local traffic is carried in a separate PDN connection; there may be another PDN connection for the traffic via the operator core network, and that traffic is not affected. The SGW 26 function is located in the operator core network.

The solution has the following main characteristics.

1. The solution does not require a standalone LGW node in the enterprise network. Instead, LGW functionality is collocated with the H(e)NB nodes.

2. Mobility is provided using L2 addressing. The terminal's IP address is mapped to a MAC (i.e., L2) address at its current H(e)NB-LGW node 10.

3. When the context is established at a new LGW entity, a L2 broadcast is sent which updates the mapping of the IP address to a MAC address at the new H(e)NB-LGW node 10 in the L2 subnet.

4. When an old LGW entity receives a L2 message which indicates that the UE's IP address is now owned by another new LGW entity in the L2 subnet, the old LGW entity releases the IP address of the terminal and (possibly after some timeout) releases the context associated with the terminal. Therefore the broadcast message in point 3 above causes an old LGW to stop owning the IP address for the same UE 16.

5. The solution does not add new signaling messages to existing mobility procedures, other than the broadcast described in point 3 above. The solution only requires new Information Elements to be added to existing messages, and possibly new, separate procedures.

6. A backup copy of the UE 16 context at the LGW is maintained in the MME 18/SGSN, to be used for setting up a new LGW context at idle to connected transition.

7. During handover procedures within the enterprise network, the LGW context of the UE 16 is transferred, together with the RAN context, from the old H(e)NB to the new H(e)NB.

8. In one optional variant of the solution, the terminal's IP address is mapped to a MAC address which is unique to the terminal, rather than to a common MAC address at the H(e)NB-LGW node 10. This allows RFC5227, IPv4 address conflict detection, to be run unchanged on the subnet. In this case, the H(e)NB-LGW nodes 10 also act as a L2 switch, and provide L2 encapsulation/decapsulation service to the terminals.

Compared to prior art, the solution is closest to [7]. However, only points 1-3 apply to the solution described in [7], and points 4-8 are different.

The main points and possible variants of the solution are described below. The procedures are presented for the LTE case in the description, but can be also applied to the 3G case as described below. Note that a HeNB GW may be present between the HeNB and the MME 18, which does not affect the procedures.

Mapping of the UE 16 IP address to a MAC address

Two variants are presented below.

Single MAC address for all UEs at a H(e)NB-LGW node 10.

In this case the IP address of the UE 16 is mapped to the H(e)NB-LGW node's own MAC address. When a LGW context is established at a H(e)NB-LGW node 10 (after mobility, or after idle to connected transition, or (optionally) for the very first time), the H(e)NB-LGW node 10 updates the IP address to MAC address at other nodes in the subnet as follows.
For IPv4, it broadcasts a gratuitous ARP in the subnet. (As described in Wikipedia (http://en.wikipedia.org/wiki/Address_Resolution_Protocol): ARP may also be used as a simple announcement protocol. This is useful for updating other hosts' mapping of a hardware address when the sender's IP address or MAC address has changed. Such an announcement, also called a gratuitous ARP message, is usually broadcast as an ARP request containing the sender's protocol address (SPA) in the target field (TPA=SPA), with the target hardware address (THA) set to zero. An alternative is to broadcast an ARP reply with the sender's hardware and protocol addresses (SHA and SPA) duplicated in the target fields (TPA=SPA, THA=SHA). Note that the use of ARP to receive packets destined to other nodes is also known as Proxy ARP.)
For IPv6, it sends an unsolicited Neighbor Advertisements (RFC 4861). Note that for IPv6, unsolicited Neighbor advertisements serve as a way to quickly update the caches in other nodes on the local network; however the old entries in the caches would anyway be updated when Neighbour Reachability Detection algorithm identifies that the old entry is no longer valid.

For a dual stack network both IPv4 and IPv6 procedures would be executed.

This approach has the advantage that only a single MAC address (and MAC instance) needs to be used at the H(e)NB-LGW node 10. On the other hand, in the case of IPv4, this approach may make it more difficult to use RFC5227, IPv4 address conflict detection. That specification is supposed to protect against misconfiguration and provide a notification when two hosts are given the same IPv4 address on the same subnet. When the old LGW receives any frame, such as the gratuitous ARP frame, that indicates that a new LGW is using the same IPv4 address, it would interpret it as IPv4 address misconfiguration, and send a warning and/or make corrective actions to reclaim the address. This can be avoided if the RFC5227 mechanism is switched off. Another possibility is to selectively disable RFC5227 for the case of 3GPP UEs and/or for the case of gratuitous ARPs. That, however, would require a modification of the RFC5227 mechanism. Another option is to configure RFC5227 such that the old LGW immediately ceases using an address when it receives a gratuitous ARP from another node, and ignore the warnings due to RFC5227. Additionally, RFC5227 also suggests that a host starting to use an IPv4 address must probe for it first to check whether other hosts are already using it in the subnet. This function needs to be turned off for LGWs after mobility or idle to connected transition, since probing takes a longer time (up to a few seconds), and this would then degrade the performance of the mobility and idle to connected mode procedures. Note that in these cases, the given address is already in use in the local subnet.

It is possible to send two or more L2 broadcast with some time interval in between, rather than a single one. This protects against the loss of the broadcast frame during congestion. Additionally, the repetition of the L2 broadcast also protects against rare but possible special situations as follows. Suppose that LGW1 was the old LGW owning the IP address of the terminal, and LGW2 is the new LGW owning the IP address of the terminal due to mobility. For IPv4, LGW2 broadcasts a gratuitous ARP to advertise its ownership of the IP address. In some rare cases a host on the subnet might have sent an ARP request for the IP address just before it receives the gratuitous ARP. LGW1 may respond to that ARP request in case LGW1 has not received the gratuitous ARP from LGW2. In that case, the host may receive the ARP reply from LGW1 after the host receives the gratuitous ARP packet. Then the host may consider that LGW1 still owns the IP address. In such a case a second gratuitous ARP from LGW2 would make it clear for the host that the IP address is now owned by LGW2. As a further protection to this issue, if the old LGW1 receives a frame with an IP packet to an address that it no longer owns (due to an old ARP cache entry), LGW1 should deliver the packet on the local subnet. Old ARP cache entries will eventually time out and this will then stop.

In the case of IPv6, a similar situation may arise when LGW2 sends an unsolicited Neighbor Advertisement at approximately the same time when a host sends a Neighbor Solicitation. Note though that for IPv6, the old entries in the caches would anyway be updated when Neighbour Reachability Detection algorithm identifies that the old entry is no longer valid.

Unique MAC address for the UEs.

In this variant, each UE 16 is assigned a dedicated MAC address which is unique within the subnet. Such a MAC address could be assigned based on some existing identifiers (IMSI, IMEI, MSISDN, IP address) or the terminal, or it could be assigned by a node (MME 18, or a local server such as a local RADIUS, DHCP or other server). The H(e)NB-LGW node 10 takes the task of encapsulating IP packets into L2 frames, and decapsulating the L2 frames for each UE 16. In other words, the H(e)NB-LGW node 10 provides a local virtual L2 interface for each UE 16.
In the case of IPv4, the ARP cache can be common for all UEs at a H(e)NB-LGW node 10. Hence the transfer of the ARP cache is not necessary during mobility (even though it is possible for quicker operation).
In the case of IPv6, the H(e)NB-LGW node 10 is responsible for defending the IPv6 address on the local subnet.

Additionally, the H(e)NB-LGW node 10 also acts as a virtual L2 switch, so that it can switch all the UEs located at the H(e)NB-LGW node 10 towards the L2 subnet. Hence, the UEs become available via the H(e)NB-LGW's L2 switch function in the local subnet.

After the terminal has moved to a new LGW, it sends a new specially formatted L2 broadcast frame with the UE's MAC address as the source L2 address. (E.g., for IPv4 this may be a gratuitous ARP packet, for IPv6 this may be an unsolicited Neighbour Advertisement packet, an IP packet to a given multicast IP address, a L2 frame with a new protocol identifier, or an L2 frame without actual user data.) This frame is used to update the L2 forwarding tables of the switches on the local subnet towards the new location of the UE 16. After the old LGW receives the broadcast frame (which can be identified also by the source MAC address), the context at the old LGW is released.

An advantage of this variant is that this does not interfere with RFC5227, since the mapping of the IPv4 address to the MAC address does not change. The ARP caches of other hosts do not need to be modified. Only the L2 forwarding tables need to be updated according to the auto-learning property of L2 switching. Similarly, for IPv6, with this variant there is no risk that an old LGW would detect that its IP address is used by a new LGW.

Another possible advantage of this approach is that a specially formatted L2 frame might in some cases be more easy to use as a trigger for actions in the node, such as releasing the LGW context, since it is easier to pass on a special frame to upper layers than a “regular” control packet that is in common use. However, the first approach of single MAC address could also be extended so that a specially formatted frame is also sent after the ARP or unsolicited neighbor advertisement message if this advantage is deemed important.

It is possible to send two or more L2 broadcast with some time interval in between. This protects against the loss of the broadcast frame in congestion. Additionally, the repetition of the L2 broadcast also protects against rare but possible special situations as follows. Suppose that LGW1 was the old LGW owning the IP address of the terminal, and LGW2 is the new LGW owning the IP address of the terminal due to mobility. LGW2 broadcasts L2 frame to advertise the new location of the MAC address of the terminal. In some cases there may be still packets from LGW1 with the same MAC address being forwarded on the subnet which causes the L2 forwarding for the MAC address to go towards LGW1. In such a case a second broadcast from LGW2 set the L2 forwarding properly towards LGW2. Note however that this is not essential: even if a frame reaches LGW1, acting as a switch it would forward it towards LGW1, or if it does not know the path towards LGW1 it would the broadcast the frame, so the frames towards the terminal would always reach LGW2.

Note that this option has a sub-variant where the L2 frame is generated by the terminal itself, rather than in the H(e)NB-LGW node 10. This would simplify the H(e)NB-LGW node 10 to a certain extent, but impact the terminal which would make this sub-variant difficult to use, since it would depend on terminal implementation that is usually difficult to ensure.

Setup of a New Local Connection

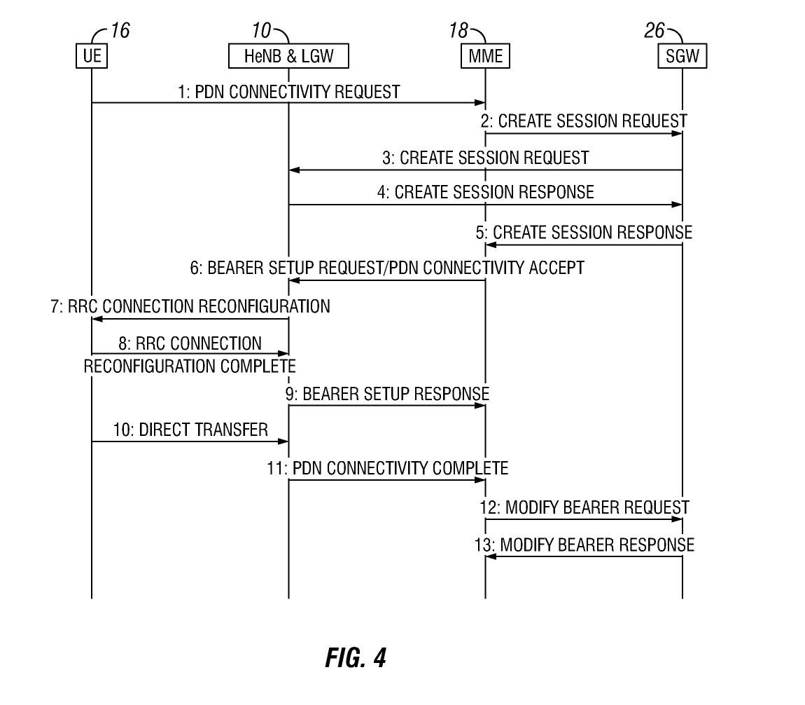

The signaling for setting up a new local connection follows the standard procedure as shown in FIG. 4. (Note that in the signaling diagrams that are shown herein, some steps may be omitted which are not relevant for the discussion.) The following steps require special attention or modification.

Step 1. As in the release-10 LIPA solution, the HeNB sends its GW IP address together with the PDN Connectivity Request message, so that the MME 18 can choose that address for the PDN GW function.

Steps 2-3. As an optional feature, the MME 18 may include an indication in these messages whether or not mobility out of the enterprise network is enabled, and consequently what method of buffering is to be used in the LGW. This indication is to be used by the LGW. The significance of the indication is that the LGW can handle incoming downlink packets in idle mode differently. If mobility out of the enterprise network is not enabled, it is possible for the LGW to send only the first packet to the SGW 26 in idle mode (in order to trigger paging) and buffer the rest. The advantage of this is higher privacy: the operator does not get access to the additional packets. In case mobility out of the enterprise network is enabled, the operator may anyway see the packets in case the terminal moves out of the enterprise, so in that case this type of privacy does not add value. In that case it is simpler if the LGW acts as normal PGWs, and forwards all downlink packets to the SGW 26 in idle mode. This avoids the issue of what trigger condition to use to release the buffered packets in the LGW.

In case a unique MAC address is to be used for each UE 16, as described below, this can be constructed as follows. Based on the identifiers that are transferred on step 2 and 3, the LGW determines a MAC address for the UE 16 on the local subnet. It may be possible that the MAC address is assigned at the MME 18 based on other identifiers, and transferred in steps 2 and 3 to the LGW. Or alternatively other identifiers such as IMSI, MSISDN, IMEI, the IP address, etc. are used at the LGW to determine a MAC address for the terminal.

Steps 4-5. The LGW context is transferred to the MME 18 via the SGW 26. The LGW context includes the IP address assigned to the UE 16, an identifier of the bearer(s) to which the LGW context applies, the unique MAC address for the UE 16 if applicable, and possibly some other parameters such as the APN, or any possible PCO (Protocol Configuration Option). The LGW context can be transferred in a “container”, meaning that the MME 18 does not need to interpret its contents, only store it for later use during after idle to connected transition.

As an alternative solution, the LGW context can also be transferred to the MME 18 on the S1 interface, in step 9 or in step 11 or in a separate message on the S1 interface after the procedure has completed, as described below.

Step 6. Besides the usual information elements, the MME 18 also sends a correlation id to the H(e)NB, just as in the release 10 LIPA solution. The correlation id is needed so that the H(e)NB context and the LGW context corresponding to the same UE 16 can be correlated within the node. One possibility is to use the TEID chosen at the LGW on S5 as the correlation id as in release 10; that correlation id should only be sent if the MME 18 has selected the LGW co-located with the H(e)NB. Alternatively, the MME 18 can also send the address of the LGW in addition to the TEID, and then the H(e)NB-LGW node 10 can recognize if the MME 18 has chosen another GW node. Alternatively, it is also possible to send the LGW context that the MME 18 has receive in step 5 since it includes the IP address, or some other identifier that can be used for correlation. (E.g., it is possible to put an explicit correlation id into the LGW context.)

Variants for Updating the LGW Address at SGW 26

Some alternative embodiments will be described in the subsequent procedures below concerning how the SGW 26 is updated about the current LGW. Note that the updating of the LGW information at the SGW 26 is not needed while the UE 16 performs connected mode mobility within the enterprise network. However, when the UE 16 becomes idle or moves out of the enterprise network, it is necessary to have the current LGW address and TEID information at the SGW 26 so that uplink packets can be sent on the S5 interface.

Alt. A: Update S5 after Each Intra-Enterprise Mobility Procedure.

In this alternative, each time a handover takes place within the enterprise, the SGW 26 is updated about the IP address and TEID used by the new LGW co-located with the new H(e)NB. As a result of this, when the UE 16 transitions to idle mode, or when the UE 16 moves out of the enterprise network, the SGW 26 is already updated about the current LGW.

Alt. B: Do not Update S5 after an Intra-Enterprise Mobility Procedure.

In this alternative, S5 is not updated after an intra-enterprise mobility procedure, so the SGW 26 does not have information about the current LGW. This does not cause a problem, since the SGW 26 is not used while the UE 16 is connected within the enterprise. In this alternative, the SGW 26 is updated when the UE 16 transitions to idle mode, or when the UE 16 moves out of the enterprise network or into the enterprise network, or when the local connection is established. This ensures that the current LGW information is available in the SGW 26 when it is needed.

Alt C: LGW Updates SGW 26 and MME 18/SGSN Via S5 and S11/S4.

In this alternative, if the LGW detects that the H(e)NB context has been released or transferred to another H(e)NB but the LGW context remains in the node, which is the case after mobility out of the enterprise or after connected to idle transition, then the LGW sends signaling to the SGW 26 via S5, which then signals to the MME 18/SGSN via S11/S4, to update the LGW address and TEID info. For this, the LGW context update procedure below can be re-used. However, the signaling contains not only the transparent LGW context, but the explicit LGW address and TEID which can be interpreted by the SGW 26 and the MME 18/SGSN. This alternative will not be discussed further in the document as it implies more signaling; nevertheless this approach is also possible.

X2 Handover within the Enterprise Network

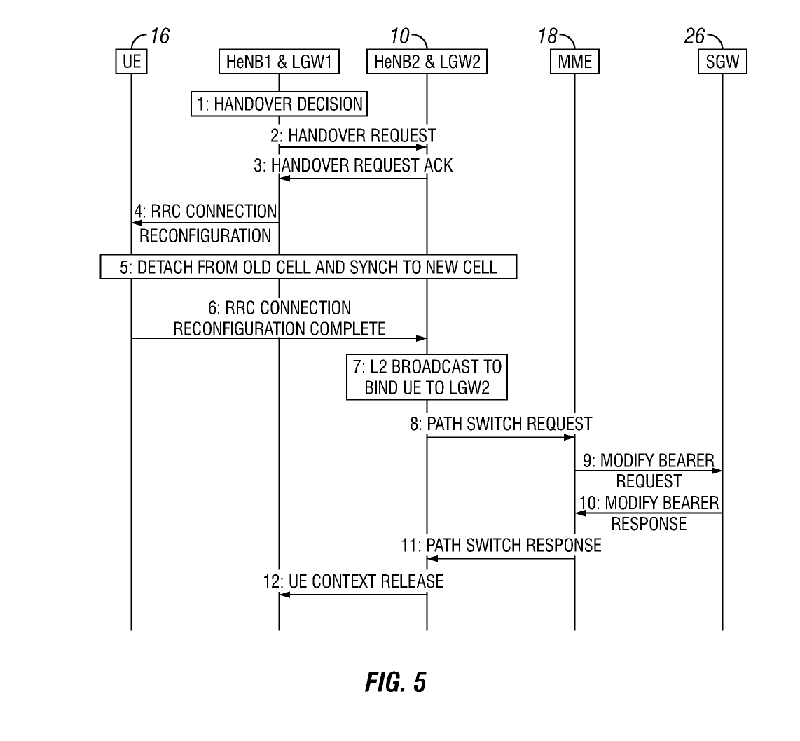

FIG. 5 shows the signaling for X2 handover within the enterprise network. The basic signaling is not affected. The steps commented below require special attention.

Step 2. Handover Request message carries not only the RAN context, but also the LGW context in a container. The transfer of the LGW context together with the HeNB context indicates to the new HeNB-LGW that it should apply LIPA on the given bearers. Even though the new HeNB2-LGW2 node receives the LGW context in step 2, it does not actually use it until the UE 16 actually turns up in step 6. In this way, the relocation of the LGW contexts in cases when the handover is prepared but does not actually take place can be avoided.

Step 7. As described above, the new HeNB-LGW performs a L2 broadcast to map the UE 16 to a local MAC address at the new node.

Steps 8-9. For Alt A, these messages contain an additional IE for the new LGW address and TEID (for both control and user plane) on S5. The MME 18 stores the information in its UE 16 context. When the SGW 26 receives this information in step 9, it updates the other endpoint of the S5 interface.

Note: in case the SGW 26 is relocated, the LGW address and TEID information is sent to the new SGW 26 as the PDN GW information.

Step 12. Note that this step only releases the context at the old HeNB. The release of the LGW context is triggered by the reception of the L2 broadcast of step 7. The old LGW immediately stops owning the IP address as it receives the broadcast of step 7. However, it may use a timeout to fully release the LGW context. In case it receives some late packets to the given IP address it can then forward them on the local subnet to the new LGW.

S1 Handover in the Enterprise Network

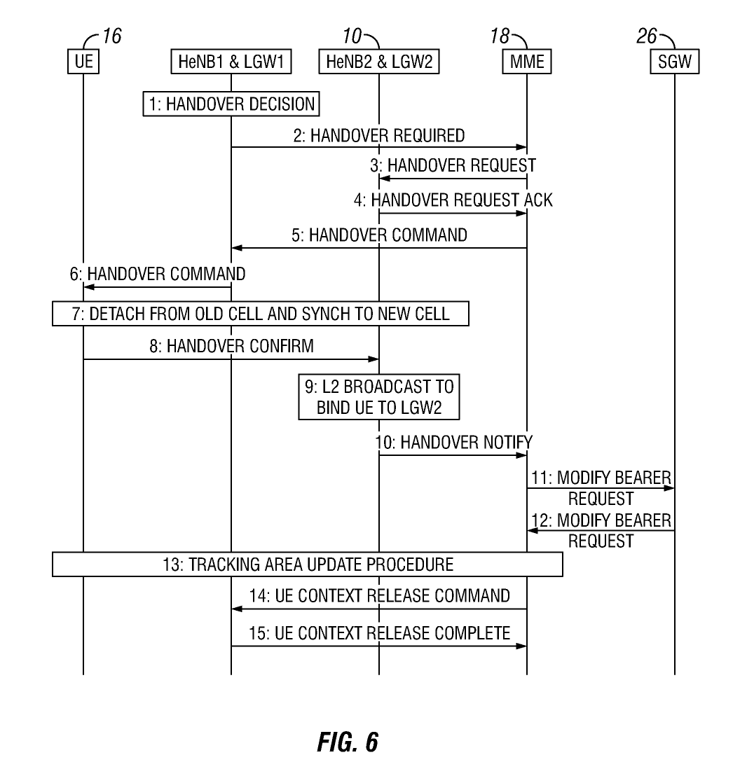

FIG. 6 shows the signaling for S1 handover within the enterprise network. The figure shows the typical case when MME 18 and SGW 26 are unchanged, even though MME 18 or SGW 26 change are also possible. The basic signaling is not affected. The steps commented below require special attention.

Steps 2-3. LGW context is transferred in a transparent container. (In the unlikely case that the MME 18 is also changed, the LGW context is also transferred from the old to the new MME 18.) The transfer of the LGW context together with the HeNB context indicates to the new HeNB-LGW that it should apply LIPA on the given bearers. Even though the new HeNB2-LGW2 node receives the LGW context in step 2, it does not actually use it until the UE 16 actually turns up in step 8. In this way, the relocation of the LGW contexts in cases when the handover is prepared but does not actually take place can be avoided.

Step 9. As described above, the new HeNB-LGW performs a L2 broadcast to map the UE 16 to a local MAC address at the new node.

Steps 10-11. For Alt A, these messages contain an additional IE for the new LGW address and TEID (for both control and user plane) on S5. The MME 18 stores the information in its UE 16 context. When the SGW 26 receives this information in step 11, it updates the other endpoint of the S5 interface.

Note: in case the SGW 26 is relocated, the LGW address and TEID information is sent to the new SGW 26.

Step 14. Note that this step only releases the context at the old HeNB. The release of the LGW context is triggered by the reception of the L2 broadcast of step 9. The old LGW immediately stops owning the IP address as it receives the broadcast of step 7. However, it may use a timeout to fully release the LGW context. In case it receives some late packets to the given IP address it can then forward on the local subnet to the new LGW.

S1 Release

This procedure is not affected at all in case Alt. A is used. For Alt B, see below.

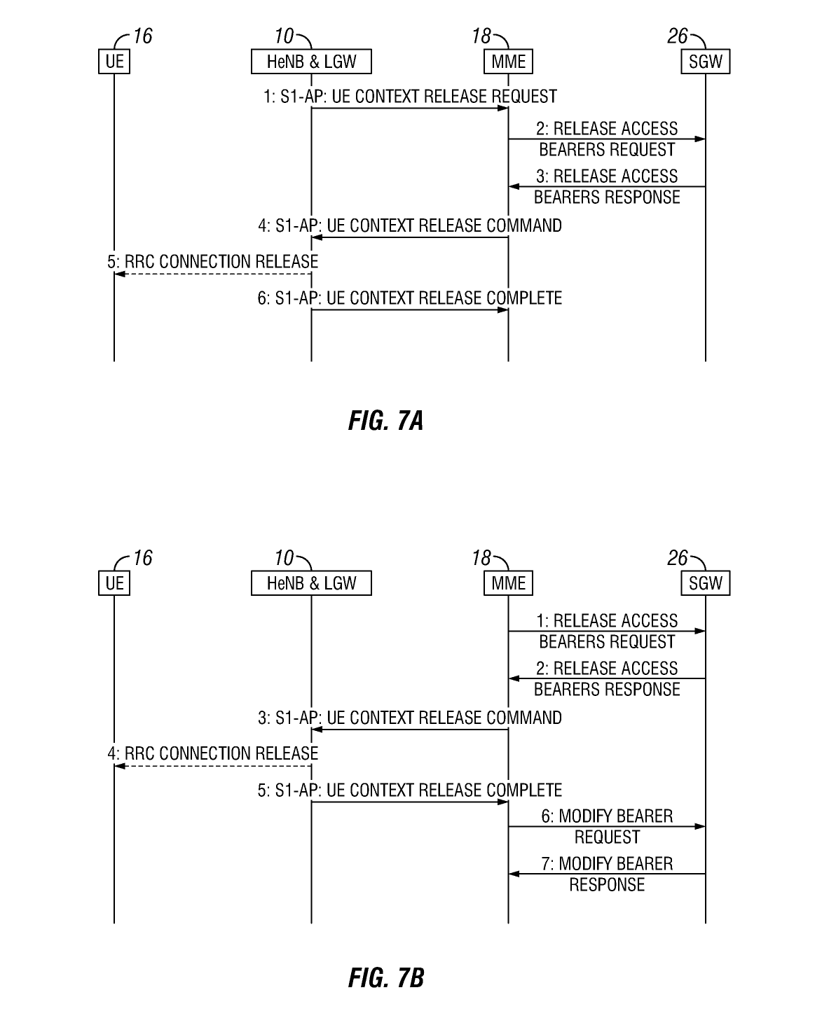

In case the S1 release is initiated from the RAN (HeNB), which is the typical case, the procedure is shown in FIG. 7a.

Step 1. The LGW address and TEID information for S5 is inserted into this message, which is stored by the MME 18.

Step 2. The LGW address and TEID information for S5 is sent to the SGW 26. After that, the SGW 26 can update its S5 endpoint to the current LGW accordingly.

In case the S1 release procedure is initiated from the MME 18, which is less typical though possible, the procedure is extended with a signaling exchange to the SGW 26 as shown in FIG. 7b.

Step 5. The LGW address and TEID information for S5 is inserted into this message, which is stored by the MME 18.

Step 6. The LGW address and TEID information for S5 is sent to the SGW 26. After that, the SGW 26 can update its S5 endpoint to the current LGW accordingly.

(As another option for the above procedure, it could be possible to have the MME 18 query the LGW information before step 1 above, and get it in a response, so that the information can be sent to the SGW 26 in step 1. That solution would avoid messages 6 and 7, but introduce an additional message exchange between MME 18 and HeNB before step 1.)

Service Request in the Enterprise Network

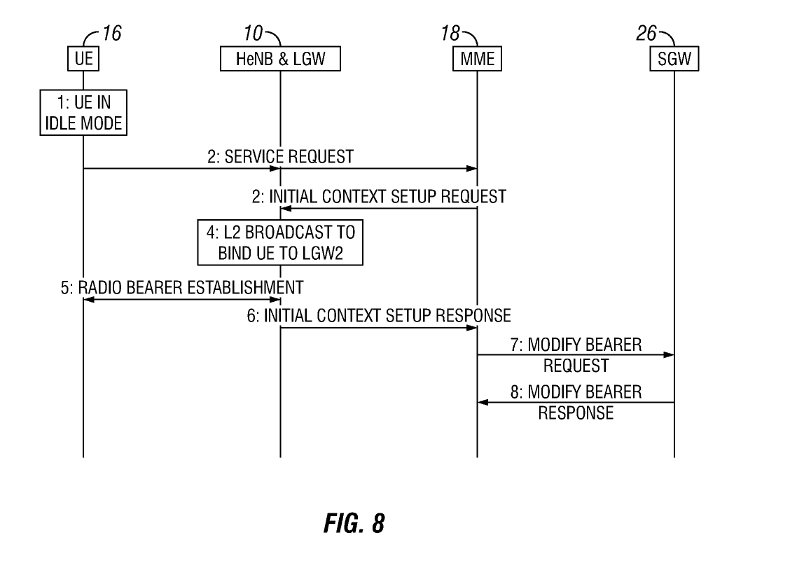

FIG. 8 shows the signaling for service request within the enterprise network. The basic signaling is not affected. The steps commented below require special attention.

Step 3: LGW context is transferred in this message to HeNB, which then sets up LGW functionality collocated with eNB for this UE 16.

Step 4: The HeNB-LGW node checks whether it already has a LGW context identical to the one received from the MME 18 in step 3. If so, this means that the LGW remains unchanged. No further action is needed in that case.

Otherwise the new HeNB-LGW performs a L2 broadcast to map the UE 16 to a local MAC address at the new node as described above. This message also triggers the release of the context at the old LGW. Should the old LGW receive a packet while this procedure takes place, it can forward it on the local subnet and it will reach the UE 16 at its new LGW.

Paging in the Enterprise Network

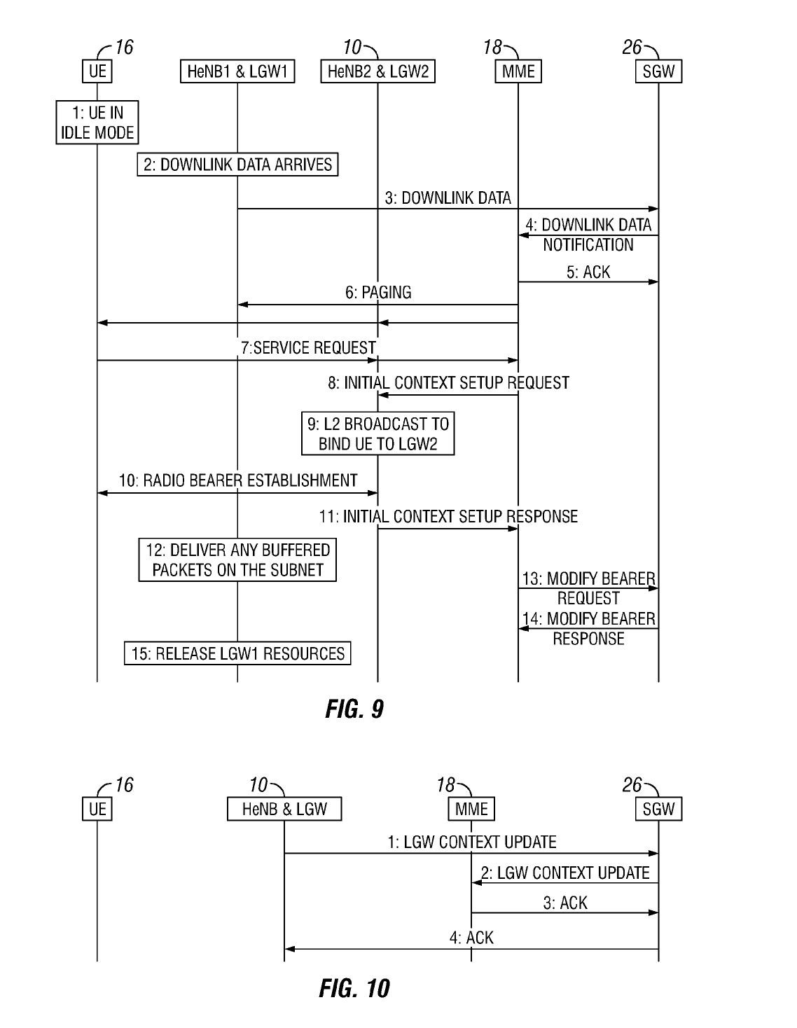

FIG. 9 shows the signaling for paging within the enterprise network. Paging takes place in idle mode, when there is a LGW with the UE 16 context, but the HeNB context has been released. In that case the downlink packet is forwarded on S5 to the SGW 26 which triggers paging, as specified today. The basic signaling is not affected. The steps commented below require special attention.

Step 8: As in Service request above, LGW context is transferred in this message to HeNB, which then sets up LGW functionality collocated with eNB for this UE 16.

Step 9: As in Service request above, the HeNB-LGW node checks whether it already has a LGW context identical to the one received from the MME 18 in step 3. If so, this means that the LGW remains unchanged. No further action is needed in that case.

Otherwise the new HeNB-LGW performs a L2 broadcast to map the UE 16 to a local MAC address at the new node as described above. This message also triggers the release of the context at the old LGW. The release may be delayed by a timeout, but it gives up the ownership of the IP address of the UE 16 immediately. Should the old LGW receive a packet while this procedure takes place, it can forward it on the local subnet and it will reach the UE 16 at its new LGW.

Step 12. Note that the release 10 LIPA solution is such that only the first downlink packet is sent to the SGW 26, and subsequent packets are buffered in the LGW. If this approach is kept for the release 11 solution, then LGW1 should deliver all buffered packets. This means that LGW1 can send those packets on the local subnet and they will reach the new LGW2 since that is the new owner of the UE's IP address. This is triggered by the broadcast L2 frame of step 9.

It is suggested here that the LGW only buffers second and subsequent downlink packets in case mobility out of the enterprise network is not supported. If mobility out of the enterprise network is supported, it is preferred that the LGW sends all downlink packets in idle mode to the SGW 26 as normally done by a PGW. The buffering of second and subsequent packets are used as a privacy measure, but if mobility is enabled the operator can anyway get access to some packets on the LIPA connection so there is no need for the LGW buffering. If this approach is taken, the MME 18 must send an indication to the HeNB-LGW node whether mobility out of the enterprise network is enabled or not. This can be done during the setup of the connection.

Step 15: After all packets have been delivered, the LGW context can be released (possibly after some timeout).

LGW Context Update

In case the context at the LGW changes, it is necessary to update its copy in the MME 18. This can be done with a message on S1 or on S5+S11. The approach of using S5+S11 signaling is preferred, because that is applicable even if the UE 16 moves out of the enterprise network.

This is new signaling, or some existing signaling can be reused with new IE.

This is needed if UE-based DHCP is used for IP address allocation, since the IP address is assigned after the PDN connection is set up. Also, in the case of IPv6, some parts of the IP address may change in some cases.

Mobility Out of/into the Enterprise Network

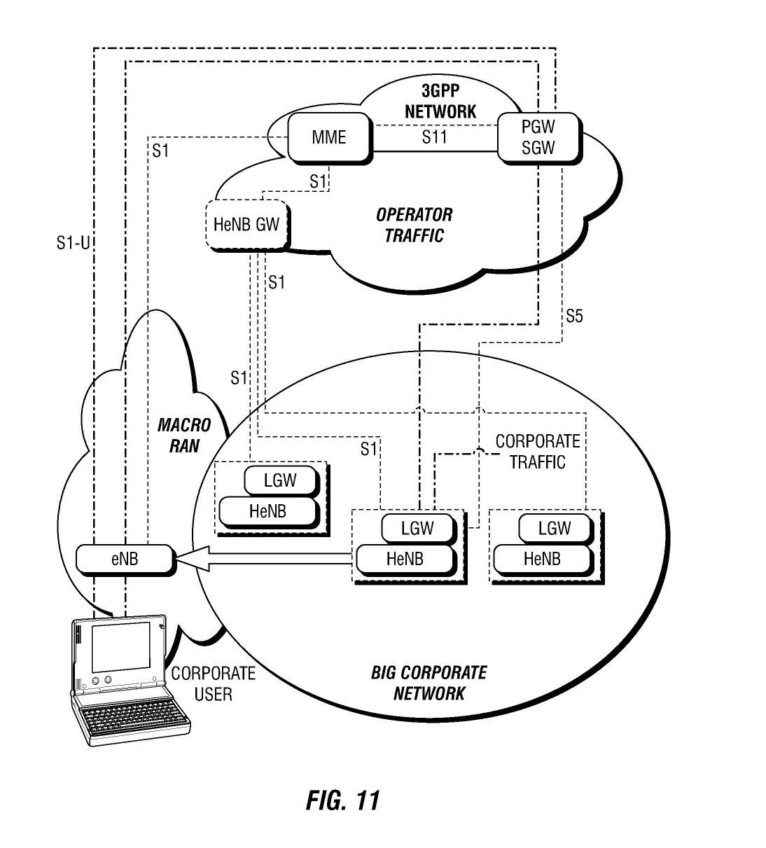

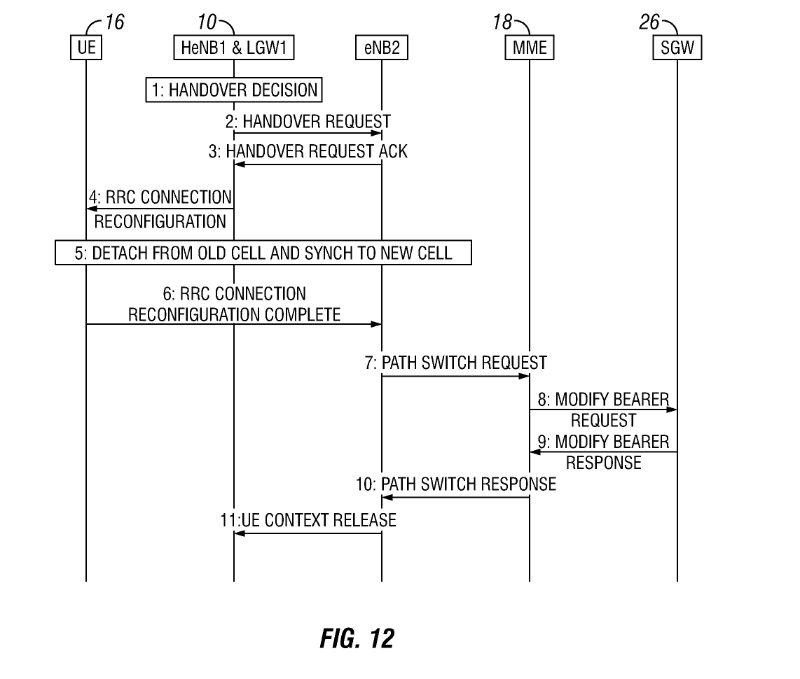

The following message flows show the cases when the terminal moves out of the enterprise network to the macro RAN coverage, or moves from macro RAN coverage into the enterprise network. The connection can be kept in these cases, so that the terminal can continue to access the enterprise network when in macro RAN coverage. As shown in FIG. 11, when the terminal moves out of the enterprise network, its LGW remains unchanged at its last location.

X2 Handover Out of the Enterprise Network

Note that this procedure is only applicable with Alt A, above, i.e., when the SGW 26 is updated about the current LGW after an intra-enterprise mobility procedure. In case Alt B is used, X2 handover out of the enterprise network should be disabled, and S1 handover out of the enterprise is needed to be used. Alternatively, Alt C may also be used with X2 handover out of the enterprise network.

Step 2: The LGW context may be included in this message, however eNB2 does not have any LGW collocated with it, and hence cannot make use of this information element. The LGW context transferred in this message will therefore be ignored at eNB2.

LGW1 will not receive any L2 broadcast from a new LGW, hence LGW1 will continue to operate in its role even after the handover procedure.

Step 7. There is no LGW information in this message. Hence the MME 18 and SGW 26 will continue to use the same LGW in line with Alt. A.

X2 Handover into the Enterprise

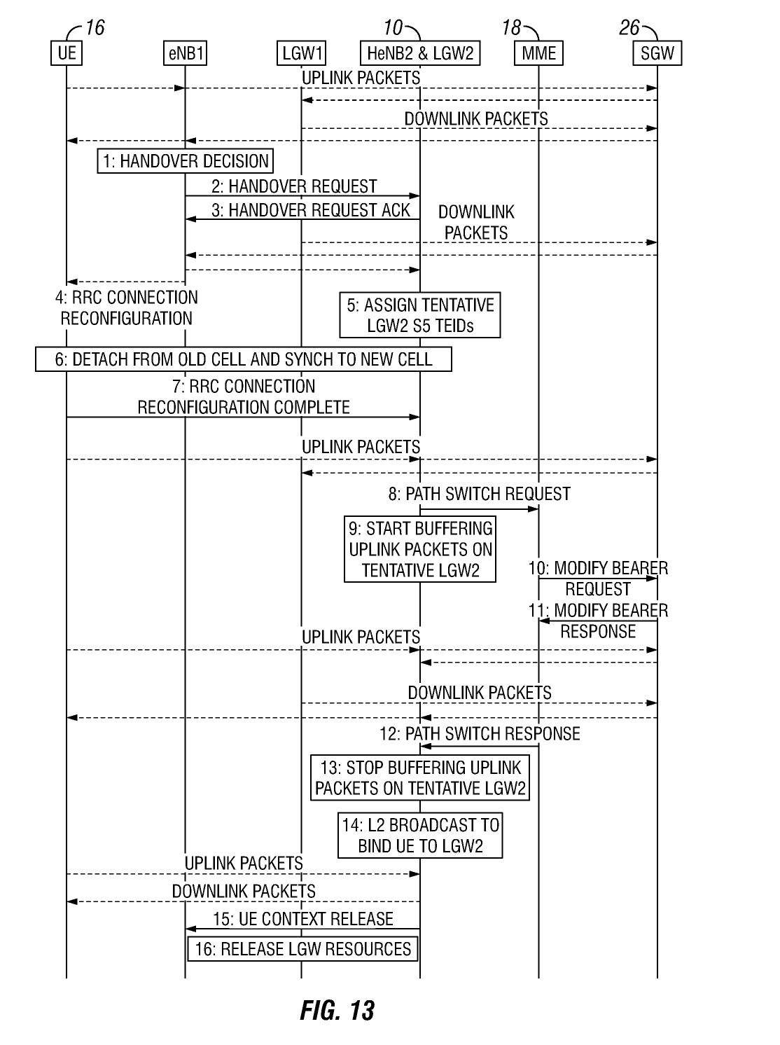

For better understanding, the signaling chart in FIG. 13 also shows the path of the user plane for uplink and downlink.

Initially, packets go via LGW1 in the enterprise network, and eNB1 is used as the RAN node which is outside the enterprise network.

Step 2: The RAN contexts are transferred to HeNB2, however there is no transfer of an LGW context since eNB1 does not have a collocated LGW. Packet forwarding is started from eNB1 to HeNB2 (if applicable).

Step 5: Since HeNB2-LGW2 node has received only a RAN context and no LGW context, it prepares for acting as a LGW by assigning tentative LGW address and TEID as S5 termination. Since the LGW has no information at this point which bearer is going to be local, it assigns these for all bearers.

Step 8: The HeNB2-LGW requests for a LGW context in this message. Additionally, the LGW informs the MME 18 of the assigned S5 termination address and TEIDs for all bearers.

Step 9: From this point, the LGW2 buffers any possible uplink packet that may arrive from the SGW 26 to the tentative S5 termination address and TEIDs. Such packets may arrive even before the Path Switch Response arrives to the HeNB2-LGW2 node. This buffering ensures that those packets are not delivered on the local subnet before the LGW context is set up. This ensures that the LGW2 node can properly handle the IP address of the UE 16 (i.e., respond to ARP requests for IPv4, or defend the IP address for IPv6).

As an alternative, it is also possible that the LGW2 learns the IP address of the UE 16 based on the source address in the uplink packets sent. In that case, the LGW can skip the buffering of step 9 and immediately start using the IP address in ARP or in IPv6 neighbor discovery. (This alternative is slightly less secure due to the learning from the UE 16, but could also be used.)

Step 10: The MME 18 checks which bearers are local, and forwards the LGW2 address and TEID to the SGW 26 only for local bearers. The SGW 26 updates the S5 termination for those bearers, and hence it sends the uplink packets to the LGW2 from this point. Note that the SGW 26 must still accept downlink packets from the old LGW1 for a while. (The S5 address and TEID for downlink at the SGW 26 must remain unchanged, or the old values must remain valid for a temporary period of time.)

Step 12: The MME 18 includes the LGW context in this message, since the MME 18 stores it as part of the UE 16 context.

Step 13: Uplink packets can now be delivered on the local subnet from this point on since the LGW context has now arrived.

Step 14: As described above, the new HeNB-LGW performs a L2 broadcast to map the UE 16 to a local MAC address at the new node. (If LGW2 determines that it already acted as the LGW for the UE 16, i.e. LGW2=LGW1, then this step can be omitted.)

Step 16: In response to the broadcast in step 14, the old LGW1 releases its resources. The release may be delayed by a timeout, but it gives up the ownership of the IP address of the UE 16 immediately. Should the old LGW1 receive a packet for the UE 16 due to some node that sends one earlier before the broadcast in step 14 has updated the caches, that packet can be delivered on the local subnet towards LGW2.

S1 Handover Out of the Enterprise

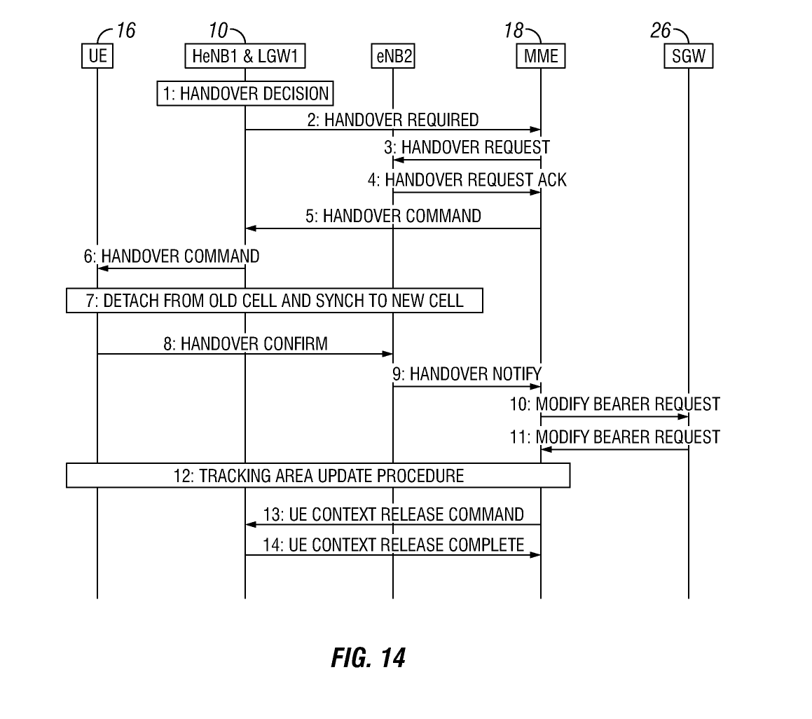

FIG. 14 shows S1 handover out of the enterprise. Note that the MME 18 and/or SGW 26 may change during the process; however this does not affect the main procedure. Note also that IRAT handover is similar to S1 handover and hence not shown separately.

Step 2-3: The LGW context may be included in these messages, however eNB2 does not have any LGW collocated with it, and hence cannot make use of this information element. The LGW context transferred will therefore be ignored at eNB2.

For Alt. B, the LGW address and TEID information is sent to the MME 18. This is needed so that the MME 18 will be able to forward it to the SGW 26 in step 10.

LGW1 will not receive any L2 broadcast from a new LGW, hence LGW1 will continue to operate in its role even after the handover procedure.

Step 9. There is no LGW information in this message. Hence the MME 18 and SGW 26 will continue to use the same LGW in the case of Alt. A.

Step 10. For Alt. B, the SGW 26 is informed about the current LGW address and TEID which was sent to the MME 18 in step 2. The SGW 26 uses this information to update the S5 accordingly.

S1 Handover into the Enterprise

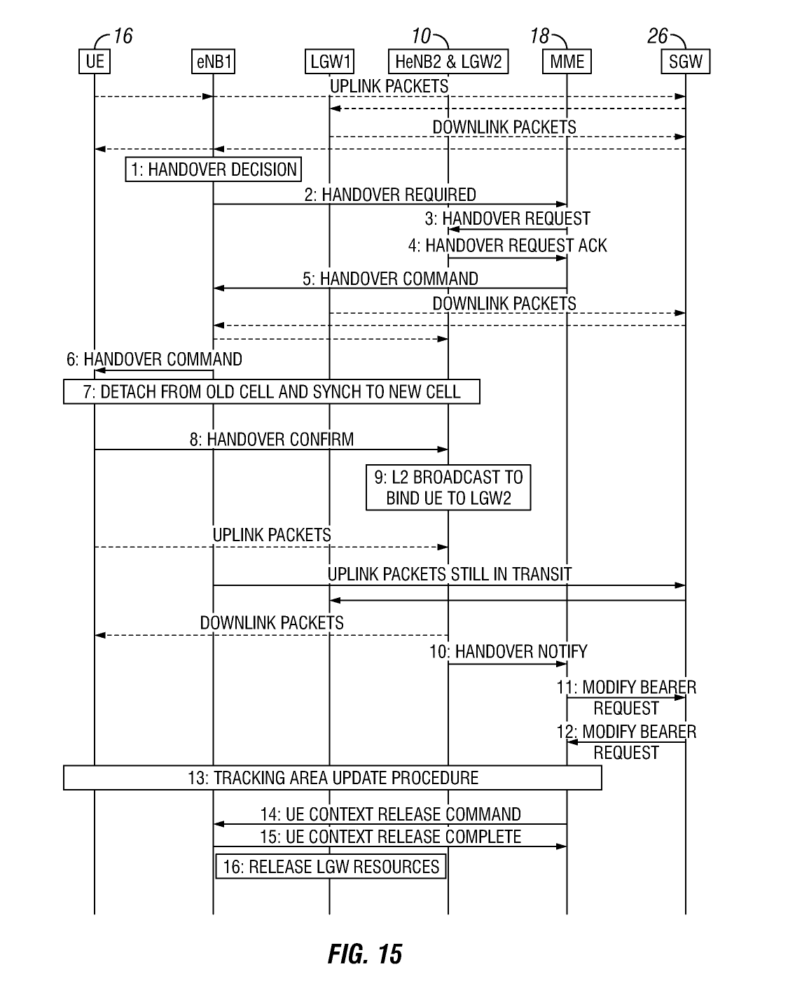

FIG. 15 shows S1 handover into the enterprise. Note that the MME 18 and/or SGW 26 may change during the process; however this does not affect the main procedure. Note also that IRAT handover is similar to S1 handover and hence not shown separately. For better understanding, the signaling chart below also shows the path of the user plane for uplink and downlink.

Initially, packets go via LGW1 in the enterprise network, and eNB1 is used as the RAN node which is outside the enterprise network.

Step 2-3: The RAN contexts are transferred to HeNB2, however there is no transfer of an LGW context since eNB1 does not have a collocated LGW. If applicable, packet forwarding is started from eNB1 to HeNB2. This may be indirect forwarding via the SGW 26.

Step 3: Since the MME 18 is aware that this is a handover into the enterprise network and that there is a local connection, the MME 18 includes the LGW context in this message.

Step 9: As described above, the new HeNB-LGW performs a L2 broadcast to map the UE 16 to a local MAC address at the new node. (If LGW2 determines that it already acted as the LGW for the UE 16, i.e. LGW2=LGW1, then this step can be omitted.)

Note that there may still be uplink packets in transit towards LGW2, as shown in the figure. LGW1 should still deliver those packets on the local subnet even though LGW1 no longer owns the IP address of the terminal, since LGW1 has received the broadcast from LGW2.

Delivering uplink packets at both LGW1 and LGW2 for a short transition period of time does not cause a problem: in case of a single MAC address per node approach, gratuitous ARP/neighbor advertisement from LGW2 has already informed other hosts that LGW2 owns the IP address of the UE 16 and that is not changed by packets delivered via LGW1. In case of a unique MAC address for each UE 16, delivering frames with the same MAC address from both LGW1 and LGW2 for a short period of time may cause some switches to forward frames with the UE 16 address as the destination towards LGW1. Then LGW1, acting as a L2 switch, would forward the frame towards LGW2, or broadcast the frame if it does not have a forwarding table entry for that MAC address. Hence, the frames will reach LGW2 as needed. Nevertheless, LGW2 may repeat the L2 broadcast of step 9 later on to make it quicker for the switches to learn LGW2 as the new destination for the terminal's MAC address.

(As another option, step 9 may be delayed if it is desired to avoid uplink packets being delivered via both LGW1 and LGW2. However, if an uplink packet arrives to LGW2 on S5, or a downlink packet arrives to HeNB2 on S1, then step 9 should not be delayed any more. Note that if step 9 is delayed, the SGW 26 may receive downlink packets on S5 from LGW1 which it must also accept even if S5 now points to LGW2.)

Step 10: LGW2 informs MME 18 about LGW2 address and TEIDs on S5 for local bearers.

Step 11: MME 18 informs SGW 26 about LGW2 address and TEIDs on S5 for local bearers.

Step 16: In response to the broadcast in step 12, the old LGW1 releases its resources. The release may be delayed by a timeout, but it gives up the ownership of the IP address of the UE 16 immediately. Should the old LGW1 receive a packet for the UE 16 due to some node that sends one earlier before the broadcast in step 14 has updated the caches, that packet can be delivered on the local subnet towards LGW2.

The Case of 3G

The procedures above have been described above for the case of LTE. They can also be applied to the corresponding 3G procedures with appropriate adaptations. For 3G, SGSN plays similar role as the MME 18, HNB plays similar role as HeNB, RNC plays similar role as eNB, S4 plays similar role as S11 interface, Iu plays similar role as S1 interface. The corresponding procedures exist for 3G as for LTE (although the message names and parameter settings are slightly different, which do not affect the proposal in this paper). Since the concept is the same for 3G as for the LTE case, the procedures are not repeated here for 3G. A reader skilled in the art should be able to draw the 3G procedures corresponding to the LTE procedures. Only some special considerations for 3G are highlighted below.

For 3G, it is possible to use the Gn reference point to a GGSN as an option rather than use a PDN GW; in that case there is no SGW 26 in the architecture. Hence, instead of the combination of the S4 and S5 interface, the Gn interface where applicable is used. Note that a HNB GW is present between the HNB and SGSN.

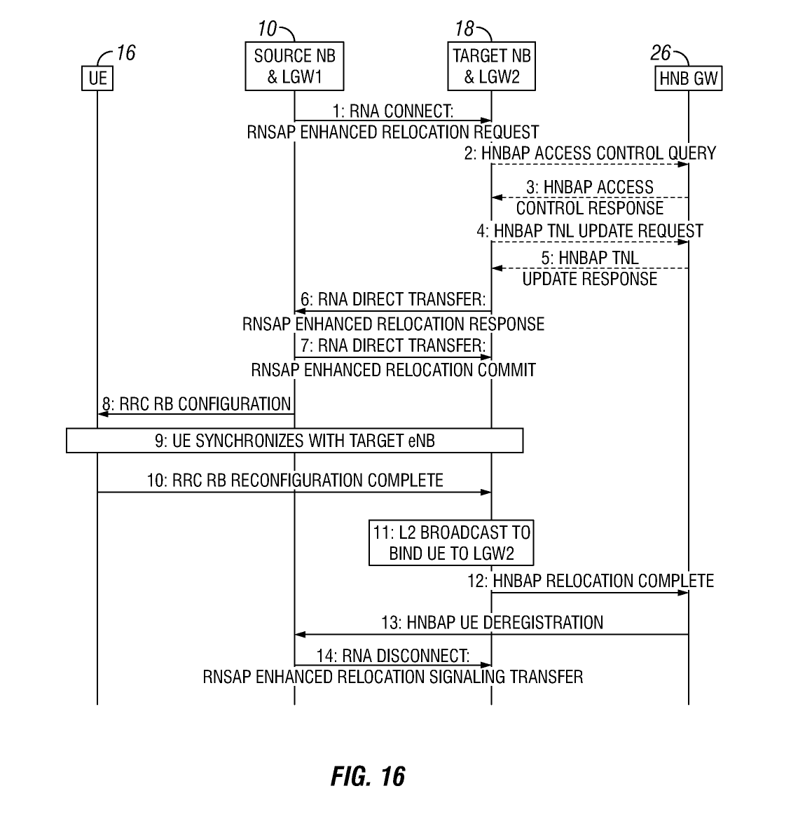

3GPP TS 25.467 [9] specifies a special HNB to HNB mobility procedure above which hides the mobility from the core network (SGSN). This is a type of mobility procedure that is not defined for LTE. The signaling is shown in FIG. 16. The following steps require special attention for Local IP Access.

Step 7. The LGW context is transferred to the target HNB in this step. However, the LGW function is not yet activated in the target HNB before handover actually takes place in step 9.

Step 11: As described above, the new HNB-LGW performs a L2 broadcast to map the UE 16 to a local MAC address at the new node.

Step 14. Note that this step only releases the context at the old HNB. The release of the LGW context is triggered by the reception of the L2 broadcast of step 11. The old LGW immediately stops owning the IP address as it receives the broadcast of step 11. However, it may use a timeout to fully release the LGW context. In case it receives some late packets it can then forward on the local subnet to the new LGW.

Note that this procedure does not have any signaling to the core network (SGSN), and hence the SGW 26 cannot be updated with the new LGW. From this it follows that Alt. A cannot be used in this case. Instead, Alt. B can be used which updates the SGW 26 with the current LGW information during connected to idle transition, or mobility out of the enterprise network.

Specification 23.467 [9] defines additional signaling messages for some mobility procedures between HNB and HNB GW, which do not affect the proposals in this paper.

The main advantages of the presented solution are that it provides a solution for mobility in an enterprise network with the following key features.
Avoids a standalone LGW in the enterprise which is difficult to manage in an enterprise network and implies an additional cost.
As a consequence of not having a standalone LGW, the extra traffic load that stems from forwarding the user plane via a standalone LGW which can in many cases be sub-optimal traffic forwarding path is also avoided.
Avoids terminal impact.
Changes in mobility and session management procedures are minimized. Only new parameters are needed, the existing mobility signaling is not impacted.

### Abbreviations

| | |
|---|---|
| ARP | Address Resolution Protocol |
| BS | Base Station |
| GGSN | Gateway GPRS Support Node |
| H(e)NB | Home (evolved) Node B |
| IRAT | Inter radio access technology |
| LGW | Local GW |
| L2 | Layer 2; Link layer |
| LI | Lawful Intercept |
| LIPA | Local IP Access |
| M2M | Machine-to-Machine |
| MME | Mobility Management Entity |
| NE | Network Entity |
| PCO | Protocol Configuration Option |
| PGW | PDN GW |
| RAN | Radio Access Network |
| SGSN | Serving GPRS Support Node |
| SGW | Serving GW |
| TEID | Tunnel Endpoint Identifier |

### REFERENCES, ALL OF WHICH ARE INCORPORATED BY REFERENCE HEREIN

[1] 3GPP TS 23.401 General Packet Radio Service (GPRS) enhancements for Evolved Universal Terrestrial Radio Access Network (E-UTRAN) access
[2] 3GPP TS 23.060 General Packet Radio Service (GPRS)
[3] Ericsson patent publication, WO2010/122511, PGW-Home (e)NB shortcut for local IP access
[4] NEC, 3GPP tdoc S2-102293, Clarification and Resolution of open issues for Solution 6
[5] Motorola, ZTE, Panasonic, 3GPP tdoc S2-102432, LIPA Solution-1, Stand-alone L-GW with Sxx being user-plane only
[6] Motorola, ZTE, Panasonic, Alcatel-Lucent, 3GPP tdoc S2-102433, LIPA Solution-1, Stand-alone L-GW with Sxx being both user-plane and control-plane
[7] LG Electronics, 3GPP tdoc 52-101361, Solution 1 variant for Inter-H(e)NB mobility with L-GW relocation
[8] Ericsson, 3GPP tdoc 52-101296, Solution 5 for corporate scenario
[9] 3GPP TS 25.467, UTRAN architecture for 3G Home Node B (HNB)

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A Home (evolved) Node B-Local Gateway (H(e)NB-LGW) node of a wireless telecommunications network having User Equipments (UEs), said H(e)NB-LGW comprising:
a network interface unit which receives a context for a UE that has moved to the H(e)NB-LGW node from an old H(e)NB-LGW node; and
a processing unit which causes a MAC broadcast to be sent by the network interface unit to a local network that updates a mapping of an IP address of the UE to a MAC address of the H(e)NB-LGW after mobility, wherein the broadcast causes the old H(e)NB-LGW node to give up ownership of the IP address for the UE.

2. The node of claim 1 wherein the context which is received by the network interface unit includes an LGW context and a Radio Access Network (RAN) context from the old H(e)NB-LGW to the H(e)NB-LGW node.

3. The node of claim 1 wherein the processing unit adds new information elements to existing messages.

4. The node of claim 1 wherein the processing unit assigns a MAC address to the UE during the establishment of a local connection, such that the MAC address is unique to the UE in the local network, the MAC address is stored in an LGW context of the UE, the processing unit uses the assigned unique MAC address as a source L2 address to encapsulate uplink IP packets from the UE before sending them to the local network via the network interface unit.

5. The node of claim 1 wherein the network interface unit receives an indication whether or not mobility out of the local network is enabled.

6. The node of claim 5, wherein the processing unit buffers downlink packets in idle mode received by the network interface unit except a first packet of the downlink packets if it is indicated that mobility out of the local network is not enabled.

7. The node of claim 1 wherein the broadcast includes a gratuitous Address Resolution Protocol (ARP) packet for IPv4, or a Neighbor Advertisement for IPv6.

8. The node of claim 4 wherein the broadcast includes an L2 frame with a unique MAC address of the UE as the source.

9. A Mobility Management Entity (MME) node of a wireless telecommunications network User Equipments (UEs), a new Home (evolved) Node B-Local Gateway (H(e)NB-LGW) node, a local network and a Serving GW (SGW), said MME node comprising:
a network interface unit which receives a Local GW (LGW) context for a UE;
a memory in which the LGW context is stored; and
a processing unit which sends the LGW context through the network interface unit to the new H(e)NB-LGW node responsive to an idle-to-connected transition by the UE or mobility by the UE into the local network.

10. The node of claim 9 wherein the processing unit updates the LGW context in the memory when the LGW context changes.

11. A Mobility Management Entity (MME) node of a wireless telecommunications network, said MME node comprising:
a network interface unit; and
a processing unit which sends through the network interface unit Local Gateway (LGW) address and Tunnel Endpoint Identifier (TEID) information to the Serving GW (SGW) during an S1 release procedure.

12. A method at a Home (evolved) Node B-Local Gateway (H(e)NB-LGW) node of a wireless telecommunications network that includes User Equipments (UEs), said method comprising the steps of:
receiving at a network interface unit of the H(e)NB-LGW node a context for a UE that has moved from an old H(e)NB-LGW to the H(e)NB-LGW node; and
sending a MAC broadcast via the network interface unit to a local network, wherein said MAC broadcast updates a mapping of an IP address of the UE to a MAC address of the H(e)NB-LGW and causes the old H(e)NB-LGW node to give up ownership of the IP address for the UE.

13. The method of claim 12 wherein the context which is received by the network interface unit includes an LGW context and a Radio Access Network (RAN) context from the old H(e)NB-LGW to the H(e)NB-LGW.

14. The method of claim 12 including the step of adding new information elements to existing messages.

15. The method of claim 12 including the step of assigning a MAC address to the UE during the establishment of a local connection, such that the MAC address is unique to the UE in the local network, storing the MAC address in the LGW context of the UE, and using the assigned unique MAC address as a source L2 address to encapsulate the uplink IP packets from the UE before sending them to the local network via the network interface unit.

16. The method of claim 12 including the step of the network interface unit receiving an indication whether or not mobility out of the local network is enabled.

17. The method of claim 16 including the step of buffering downlink packets in idle mode received by the network interface unit except a first packet of the downlink packets if it is indicated that mobility out of the local network is not enabled.

18. The method of claim 12 wherein the broadcast includes a gratuitous Address Resolution Protocol (ARP) packet for IPv4, or a Neighbor Advertisement for IPv6.

19. The method of claim 15 wherein the broadcast includes an L2 frame with the UE's unique MAC address as the source.

20. A method at a Mobility Management Entity (MME) node of a wireless telecommunications network that includes User Equipments (UEs), a new Home (evolved) Node B-Local Gateway (H(e)NB-LGW) node, a local network and a Serving GW (SGW), and wherein the method comprises the steps of:
receiving at a network interface unit a Local GW (LGW) context for a UE;
storing the LGW context in a memory; and
sending the LGW context through the network interface unit to the new H(e)NB-LGW node responsive to an idle-to-connected transition by the UE or mobility by the UE into the local network

21. The method of claim 20 including the step of the processing unit updating the LGW context in the memory when the LGW context changes.

22. A method at a Mobility Management Entity (MME) node of a wireless telecommunications network having a Serving Gateway (SGW), comprising sending an LGW address and Tunnel Endpoint Identifier (TEID) information to the SGW during an S1 release procedure.
